(19) United States
(12) Patent Application Publication
(10) Pub. No.: US 2021/0300326 A1
(43) Pub. Date: Sep. 30, 2021

(54) CONTROL DEVICE FOR HYBRID VEHICLE

(71) Applicant: Honda Motor Co., Ltd., Tokyo (JP)

(72) Inventors: Osamu SHIRAI, Saitama (JP); Ken HAYASAKA, Saitama (JP); Motoki MIZUSHIMA, Saitama (JP); Hisashi ISHIKAWA, Saitama (JP); Ichiro INABA, Saitama (JP); Hiroyuki MURAKAMI, Saitama (JP)

(73) Assignee: Honda Motor Co., Ltd., Tokyo (JP)

(21) Appl. No.: 17/211,887

(22) Filed: Mar. 25, 2021

(30) Foreign Application Priority Data
Mar. 26, 2020 (JP) 2020-056687

(51) Int. Cl. B60W 20/13; B60L 1/02

(52) U.S. Cl. CPC B60W 20/13; B60W 2510/246; B60W 2510/0638; B60L 1/02

(57) ABSTRACT

The disclosure provides a control device for a hybrid vehicle, which can prevent overcharging the battery and effectively utilize the power generated by an electric motor operating as a generator to avoid useless wasted power. The hybrid vehicle includes an engine, an electric motor, a battery, an engine rotational speed sensor, a battery temperature sensor, and a fuel cutting part that stops the operation of the engine according to a specified operating condition. In the state where the operation of the engine is stopped by the fuel cutting part, the control device operates the electric motor as a generator when the rotational speed of the engine is equal to or below a specified value and the battery is chargeable in terms of temperature, and drives a heater with the power generated by the electric motor operating as a generator when the battery is unchargeable in terms of remaining capacity.

### CROSS-REFERENCE TO RELATED APPLICATION

This application claims the priority benefits of Japanese application no. 2020-056687, filed on Mar. 26, 2020. The entirety of the above-mentioned patent application is hereby incorporated by reference herein and made a part of this specification.

### TECHNICAL FIELD

The disclosure relates to a control device for a hybrid vehicle traveling with an engine and an electric motor as driving sources.

### DESCRIPTION OF RELATED ART

A hybrid vehicle including an engine and an electric motor as driving sources is capable of cleaning exhaust gas and improving fuel efficiency by assisting the driving force of the engine with the electric motor. In such a hybrid vehicle, driving states of the vehicle such as an accelerator position or a vehicle speed are detected to control the division of use between the engine and the electric motor.

The battery in the hybrid vehicle is charged by the generated power generated by driving torque of the engine and regenerative power generated by regenerative torque during braking. In this case, for example, the driving torque of the engine is changed according to the state of charge (SOC) to prevent overcharging the battery.

In addition, some hybrid vehicles are designed to stop the drive of engines according to the specified operating conditions to further improve fuel efficiency and reduce exhaust gas emissions.

For example, the hybrid vehicle proposed in Patent Document 1 stops the engine by cutting the fuel (idling stop) when the state of charge (SOC) exceeds a specified value, and drives the engine in the range of high efficiency when the state of charge is below the specified value in the case where the accelerator position is at 0%.

In addition, the engine control device for the hybrid vehicle proposed in Patent Document 2 cuts the fuel to stop the engine (idling stop) according to the specified operating conditions, yet during this progress, when the engine rotational speed drops to or below the specified value, the engine control device operates the electric motor as a generator and applies load to the engine to change the natural frequency of the vibration system, and passes the range of resonance quickly, thereby suppressing the vibration of the vehicle body.

[Patent Document 1] Japanese Laid-Open No. H8-317505

[Patent Document 2] Japanese Laid-Open No. 2000-257463

However, in the engine control device for the hybrid vehicle proposed in Patent Document 2, the power generated with the electric motor operating as a generator when the engine is stopped by cutting the fuel is, for example, charged to the battery, but when the remaining capacity of the battery is insufficient, to prevent overcharging the battery, the generated power has to be discharged (wasted), which is undesirable from the viewpoint of effective use of energy.

### SUMMARY

The disclosure provides a control device for a hybrid vehicle, wherein the hybrid vehicle includes: an engine (1) and an electric motor (2), as driving sources; a battery (6), supplying power to the electric motor (2); an engine rotational speed detecting part (S5), detecting a rotational speed of the engine (6); a battery temperature detecting part (S7), detecting a temperature of the battery (6); and a fuel cutting part, cutting fuel supply to the engine (1) according to a specified operating condition to stop an operation of the engine (1). The control device for the hybrid vehicle is configured to: enable the electric motor (2) to operate as a generator when the rotational speed of the engine (1) detected by the engine rotational speed detecting part (S5) is equal to or below a specified value and the battery (6) is in a chargeable state in terms of temperature in a state where the operation of the engine (1) is stopped by the fuel cutting part; charge the battery (6) with power generated by the electric motor (2) operating as the generator when the battery (6) is in the chargeable state in terms of remaining capacity; and drive an auxiliary equipment (7) with the power generated by the electric motor (2) operating as the generator when the battery (6) is in an unchargeable state in terms of remaining capacity.

### BRIEF DESCRIPTION OF THE DRAWINGS

FIG. 1 is a block diagram showing a basic configuration of a hybrid vehicle including a control device according to the disclosure.

FIG. 2 is a flowchart showing a control procedure of a control device according to the disclosure.

FIG. 3 is a timing chart showing time changes of an engine rotational speed, a heater, and charged power of a battery under control of a control device according to the disclosure.

### DESCRIPTION OF THE EMBODIMENTS

The disclosure provides a control device for a hybrid vehicle, which is capable of preventing overcharging the battery and effectively utilizing the power generated by the electric motor operating as a generator to avoid useless wasted power.

The disclosure provides a control device for a hybrid vehicle, wherein the hybrid vehicle includes: an engine (1) and an electric motor (2), as driving sources; a battery (6), supplying power to the electric motor (2); an engine rotational speed detecting part (S5), detecting a rotational speed of the engine (6); a battery temperature detecting part (S7), detecting a temperature of the battery (6); and a fuel cutting part, cutting fuel supply to the engine (1) according to a specified operating condition to stop an operation of the engine (1). The control device for the hybrid vehicle is configured to: enable the electric motor (2) to operate as a generator when the rotational speed of the engine (1) detected by the engine rotational speed detecting part (S5) is equal to or below a specified value and the battery (6) is in a chargeable state in terms of temperature in a state where the operation of the engine (1) is stopped by the fuel cutting part; charge the battery (6) with power generated by the electric motor (2) operating as the generator when the battery (6) is in the chargeable state in terms of remaining capacity; and drive an auxiliary equipment (7) with the power generated by the electric motor (2) operating as the generator when the battery (6) is in an unchargeable state in terms of remaining capacity.

According to the disclosure, when the fuel supply to the engine is cut for the specified operating condition is met and the engine stops, the engine rotational speed gradually drops. When the engine rotational speed is equal to or below the specified value and the battery is in the chargeable state in terms of temperature, the power generated by the electric motor operating as a generator is used to charge the battery when the battery is in the chargeable state in terms of remaining capacity, and the power is effectively used to drive the auxiliary equipment when the battery is in the unchargeable state in terms of remaining capacity. Therefore, it is possible to prevent overcharging the battery and effectively utilize the power generated by the electric motor operating as a generator to avoid useless wasted power.

Here, the specified value of the rotational speed of the engine (1) may be a value that is equal to or below an idling rotational speed and is set in a range of a bandwidth of a resonant frequency of a vehicle body and a driving system. In addition, the auxiliary equipment (7) may be a heater.

According to the disclosure, the effects of preventing overcharging the battery and effectively utilizing the power which is generated by the electric motor operating as a generator to avoid useless wasted power are achieved.

An embodiment of the disclosure is described below with reference to the accompanying drawings.

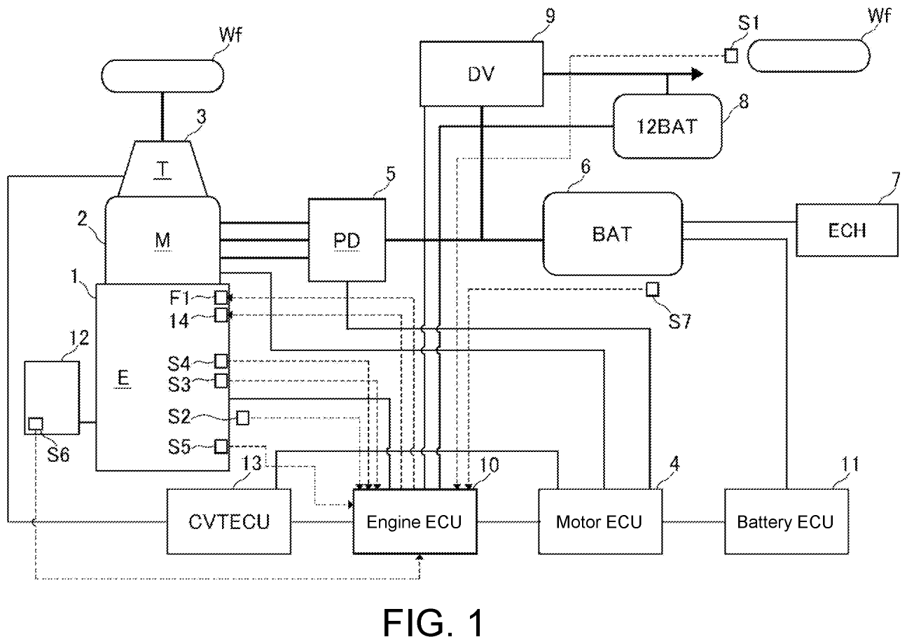

FIG. 1 is a block diagram showing a basic configuration of a hybrid vehicle including a control device according to the disclosure. The hybrid vehicle shown is a parallel hybrid vehicle, specifically, a vehicle equipped with a manual transmission (including a vehicle equipped with a continuously variable transmission (CVT)).

The hybrid vehicle according to the embodiment is an FF (front-engine front-drive) vehicle provided with an engine (E) 1 and an electric motor (M) 2 as driving sources. The driving force of the engine 1 and the electric motor 2 is transmitted through a transmission (T) 3 to front wheels Wf which are the left and right driving wheels, and the left and right front wheels Wf are rotationally driven, respectively. Thereby, the hybrid vehicle travels. Then, in the hybrid vehicle, when a driving force is transmitted from the side of the front wheels Wf to the side of the electric motor 2 during deceleration, the electric motor 2 operates as a generator to generate a regenerative braking force, and the kinetic energy of the vehicle body is converted into electric energy and recovered.

The driving and regenerative operations of the electric motor 2 are performed by a power drive unit (PD) 5 which operates in response to control commands from a motor ECU 4. Furthermore, a high-voltage battery (BAT) 6 which exchanges electric energy with the electric motor 2 is electrically connected to the power drive unit 5. Here, the battery 6 is, for example, configured by connecting a plurality of modules in series, wherein 1 unit of the module is a plurality of cells connected in series, and a heater (ECH) 7 which is used as auxiliary equipment is electrically connected thereto.

In addition, the hybrid vehicle is equipped with a 12-volt auxiliary battery (12BAT) 8 to drive various auxiliary equipment, and the auxiliary battery 8 is electrically connected to the battery 6 through a down converter (DV) 9. Here, the down converter 9 is controlled by an engine ECU 10 and realizes the function of charging the auxiliary battery 8 with the voltage of the battery 6.

Moreover, the hybrid vehicle is provided with a battery ECU 11 for calculating the state of charge (SOC) of the battery 6, a brake negative pressure device 12, a CVTECU 13, and the like. Here, the engine ECU 10 controls the battery ECU 11 and the down converter 9, and controls the operation of a fuel supply amount control part F1 which controls the fuel supply amount to the engine 1, and the operation and ignition timing of a starter motor (ST) 14. Therefore, the information of the battery state of charge (SOC) from the battery ECU 11, the information of motor from the motor ECU 4, and the signals from various sensors and switches are input to the engine ECU 10.

As the various sensors, a vehicle speed sensor S1, a throttle position sensor S2, an engine water temperature sensor S3, an engine intake air temperature sensor S4, an engine rotational speed sensor S5, a brake negative pressure sensor S6, and a battery temperature sensor S7 detecting the temperature of the battery 6 are provided. In addition, as the various switches, an ignition switch, a reverse switch, a brake switch, a neutral switch, a clutch switch (none is shown in the figure) and the like are provided.

Also, when the signals from the various sensors S1 to S7, the signals from the various switches, the information of the state of charge (SOC), the information of the electric motor 2, and the like are transmitted to the engine ECU 10, the engine ECU 10 cuts the fuel for the engine 1 by a fuel cutting part not shown in the figure to stop the operation of the engine 1, or launches the starter motor 14 to start the engine 1. Furthermore, in the case that the hybrid vehicle is equipped with a CVT (continuously variable transmission), a position switch which detects the positions of N (neutral), P (parking), and R (reverse) is provided instead of the neutral switch, reverse switch, and clutch switch.

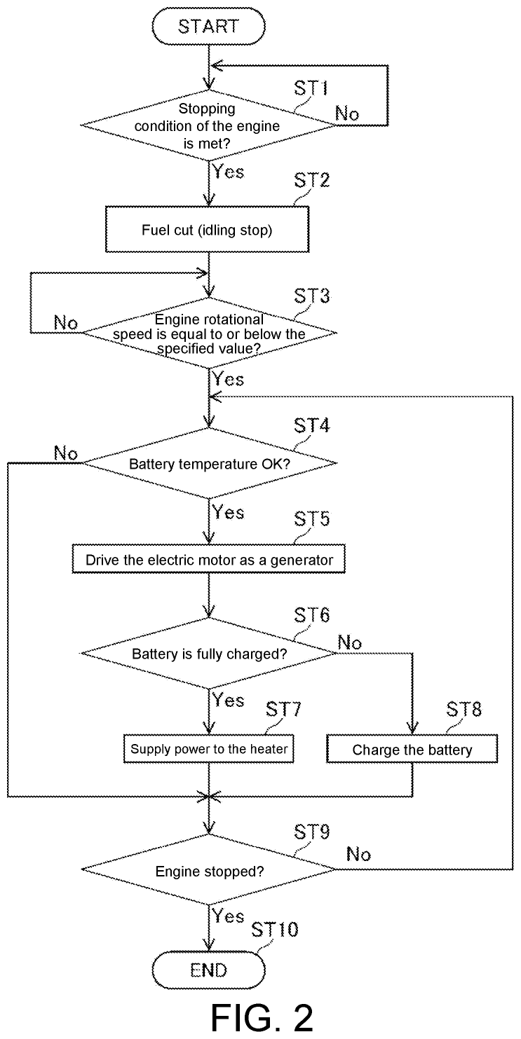

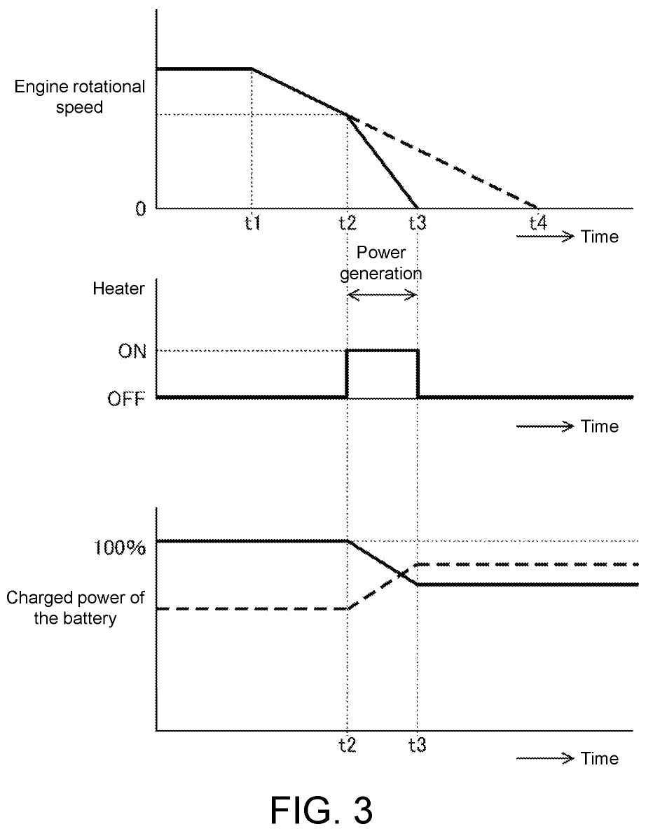

Next, the control of the hybrid vehicle, which is configured as above, during idling stop is described below with reference to FIG. 2 and FIG. 3.

FIG. 2 is a flowchart showing the control procedure of the control device according to the disclosure. FIG. 3 is a timing chart showing the time changes of the engine rotational speed, the heater, and the charged power of the battery under control of the same control device.

In the case that the engine 1 is idling stopped, the engine ECU 10 determines the operating state of the vehicle based on the various information input from the various sensors S1 to S7, and the operating state determines whether or not a stopping (idling stop) condition of the engine 1 (for example, the throttle position of the engine 1 detected by the throttle position sensor S2 is 0%) is met (step ST1 in FIG. 2). In the case that the result of this determination is that the stopping condition of the engine 1 is met (step ST1: Yes), the fuel supply to the engine 1 is cut (blocked) by the fuel cutting part not shown in the figure (step ST2). On the other hand, in the case that the stopping condition of the engine 1 is not met (step ST1: No), the determination in step ST1 is repeated.

When the stopping condition of the engine 1 is met at the time t1 shown in FIG. 3 (step ST1: Yes) and the fuel supply to the engine 1 is cut (step ST2), the engine rotational speed detected by the engine rotational speed sensor S5 (refer to FIG. 1) gradually drops as shown in FIG. 3. The engine ECU 10 determines whether or not the rotational speed of the engine 1 has dropped to or below a specified rotational speed (step ST3). Here, the specified value of the engine rotational speed is, for example, a value that is equal to or below the idling rotational speed and is set in the range of a bandwidth of the resonant frequency of the vehicle body and the driving system.

When the engine rotational speed drops to or below the specified value at the time t2 shown in FIG. 3 (step ST3: Yes), the engine ECU 10 determines whether or not the battery 6 is in a chargeable state in terms of temperature based on the temperature of the battery 6 detected by the battery temperature sensor S7 (step ST4).

In the case that the result of the above determination is that the battery 6 is determined as chargeable in terms of temperature (step ST4: Yes), the electric motor 2 operates as a generator (step ST5), and while the electric motor 2 generates power, whether or not the battery 6 is chargeable in terms of remaining capacity is determined (that is, whether or not the battery 6 is full and further charging becomes overcharging) (step ST6). In the case that the result of this determination is that the remaining capacity of the battery 6 is almost 0 (for example, the charged power of the battery 6 is 100% (remaining capacity (SOC) is 0) as shown by the solid line in FIG. 3), the battery ECU 11 which receives commands from the engine ECU 10 transmits a control signal to the battery 6, supplies (conducts) the power generated by the electric motor 2 operating as a generator to the heater 7, and drives the heater 7 (ON) to generate heat as shown in FIG. 3 (step ST7). The power supply (conduction) to the heater 7 is continued until the time t3 (refer to FIG. 3) when the engine 1 stopped. Since the power charged to the battery 6 is consumed by the power supply (conduction) to the heater 7, while the charged power of the battery 6 drops as shown by the solid line in FIG. 3 to prevent overcharging the battery 6, the power generated by the electric motor 2 is effectively utilized by the heater 7.

On the other hand, as shown by the broken line in FIG. 3, in the case that the charged power of the battery 6 is less than 100% and the battery 6 is chargeable in terms of the remaining capacity (step ST6: No), the power generated by the electric motor 2 which operates as a generator is supplied to the battery 6 and used for charging the battery 6 (step ST8). As a result, the charged power of the battery 6 gradually increases during the times t2 to t3 as shown by the broken line in FIG. 3.

In addition, from the time when the electric motor 2 operates as a generator (time t2), because load is applied to the engine 1, the rotational speed of the engine 1 drops sharply as shown in FIG. 3. However, in the case that the electric motor 2 is not operated as a generator, the rotational speed of the engine 1 gradually drops as shown by the broken line in FIG. 3 until the time t4 when the engine 1 stops. When the electric motor 2 operates as a generator in this way, since the engine 1 can be stopped quickly, the time of the engine rotational speed being in the bandwidth of the resonant frequency can be kept short, which consequently suppresses unpleasant vibration of the vehicle body.

Then, after that, whether or not the engine 1 has stopped is determined (step ST9). In the case that the engine 1 is not stopped (step ST9: No), the above processes (the processes of steps ST4 to ST8) are executed until the engine 1 stops (during the times t2 to t3 shown in FIG. 3), and at the time when the engine 1 stops (time t4 in FIG. 3), a series of processes is finished (step ST10).

On the other hand, in the case that the result of the determination in step ST4 is that charging the battery 6 is impossible in terms of temperature (for example, when the temperature of the battery 6 is high), whether or not the engine 1 has stopped is determined (step ST9). In the case that the engine 1 has stopped (step ST9: Yes), a series of processes is finished at the time (time t4 in FIG. 3) when the engine 1 stops (step ST10). In contrast, in the case that the engine 1 is not stopped (step ST9: No), the engine 1 is naturally stopped without the electric motor 2 operating as a generator.

As described above, when the fuel supply to the engine 1 is cut for the specified operating condition is met and the engine 1 stops, the engine rotational speed gradually drops. In the embodiment, when the engine rotational speed is equal to or below the specified value and the battery 6 is in the chargeable state in terms of temperature, the power generated by the electric motor 2 operating as a generator is used to charge the battery 6 when the battery 6 is in the chargeable state in terms of remaining capacity, and the power is supplied to the heater 7 to be used for heating of the heater when the battery 6 is in the unchargeable state in terms of remaining capacity. Therefore, according to the embodiment, the effects of preventing overcharging the battery 6 and effectively utilizing the power generated by the electric motor 2 operating as a generator to avoid useless wasted power are achieved.

Moreover, in the embodiment, in the case that the remaining capacity of the battery 6 is insufficient and the battery 6 may be overcharged, the power generated by the electric motor 2 operating as a generator is supplied to the heater 7 to be used for heating. However, it goes without saying that the target to which the power is supplied is not limited to the heater 7 in such a case, and may be any other auxiliary equipment.

In addition, the disclosure is not limited to the embodiments described above, and various modifications may be made within the scope of the claims and the technical ideas described in the specification and drawings.

What is claimed is:

1. A control device for a hybrid vehicle, wherein the hybrid vehicle comprises: an engine and an electric motor, as driving sources; a battery, supplying power to the electric motor; an engine rotational speed detecting part, detecting a rotational speed of the engine; a battery temperature detecting part, detecting a temperature of the battery; and a fuel cutting part, cutting fuel supply to the engine according to a specified operating condition to stop an operation of the engine, wherein the control device for the hybrid vehicle is configured to:
enable the electric motor to operate as a generator when the rotational speed of the engine detected by the engine rotational speed detecting part is equal to or below a specified value and the battery is in a chargeable state in terms of temperature in a state where the operation of the engine is stopped by the fuel cutting part;
charge the battery with power generated by the electric motor operating as the generator when the battery is in the chargeable state in terms of remaining capacity; and
drive an auxiliary equipment with the power generated by the electric motor operating as the generator when the battery is in an unchargeable state in terms of remaining capacity.

2. The control device for the hybrid vehicle according to claim 1, wherein
the specified value of the rotational speed of the engine is a value that is equal to or below an idling rotational speed and is set in a range of a bandwidth of a resonant frequency of a vehicle body and a driving system.

3. The control device for the hybrid vehicle according to claim 1, wherein
the auxiliary equipment is a heater.

4. The control device for the hybrid vehicle according to claim 2, wherein
the auxiliary equipment is a heater.
